(19) United States
(12) Patent Application Publication
(10) Pub. No.: US 2013/0338875 A1
(43) Pub. Date: Dec. 19, 2013

(54) METHOD AND DEVICE FOR DETERMINING A POWER RESERVE OF AN ELECTRIC DRIVE

(71) Applicants: Karl-Ernst Weiss, Ettlingen (DE); Fanny Kobiela, Walheim (DE); Frank Beruscha, Kleingattbach (DE); Arnd Engeln, Tuebingen (DE); Clemens Guenther, Ettlingen (DE); Claus Marberger, Weil Der Stadt (DE)

(72) Inventors: Karl-Ernst Weiss, Ettlingen (DE); Fanny Kobiela, Walheim (DE); Frank Beruscha, Kleingattbach (DE); Arnd Engeln, Tuebingen (DE); Clemens Guenther, Ettlingen (DE); Claus Marberger, Weil Der Stadt (DE)

(21) Appl. No.: 13/995,031

(22) PCT Filed: Oct. 20, 2011
(86) PCT No.: PCT/EP11/68318

§ 371 Date: Aug. 29, 2013

(30) Foreign Application Priority Data
Dec. 17, 2010 (DE) 102010063358.5

(51) Int. Cl. B60L 11/18

(52) U.S. Cl. CPC B60L 11/18
USPC 701/34.4

(57) ABSTRACT

A method for determining a power reserve of an electric drive, particularly for use in a drive train of a motor vehicle, having the steps: determining a power limit of the electric drive which forms the limit of the convertible power of the electric drive; recording a requested, provided or applied torque of the electric drive; determining a power reserve which forms a power that is implementable above the requested, provided or applied torque within the determined power limit of the electric drive; and displaying the power reserve using a display.

### FIELD

The present invention relates to a method for determining a power reserve of an electric drive, particularly for use in a drive train of a motor vehicle. The present invention also relates to a device for determining a power reserve of an electric drive, particularly for use in a drive train of a motor vehicle. Furthermore, the present invention relates to a motor vehicle drive train having an electric drive for providing drive power and a device of the type described above.

### BACKGROUND INFORMATION

In the field of automotive driving technology, an electric machine is conventionally used as the sole drive (electrical vehicle) or jointly with a drive motor of a different type (hybrid drive). In a vehicle that has exclusively an internal combustion engine, the driver expects a constant acceleration behavior at a given rotational speed and a given gear setting. This behavior is not necessarily a certainty at high accelerations in electrically driven vehicles (or in the case of hybrid vehicles in purely electrical drive). Durable demand for a high torque leads to the heating of the electrical components of the drive such as the electric machine or the control electronics. These electric components may be increasingly damaged by the lasting thermal load. That is why it is usually necessary to regulate down the torque, provided the electric components are guided to their thermal load limit, to avoid permanent damage to the electric components. Electric components in an electric drive may likewise be damaged in the case of a lasting thermal load that is produced by a high regenerative torque, i.e., a torque recovering energy.

Conventionally, the driver receives no warning or feedback that announces such an active regulating down of the torque ahead of time. One disadvantage in this case is that an accustomed or expected motor power for the case of the active regulating down is not available without prior announcement, whereby dangerous or danger-bringing situations may be created. Furthermore, the active regulating down of the torque may lead to dissatisfaction of the driver, because continuous power availability is not a given

A method for reducing overheating of a drive machine is described in Japanese Patent Application No. JP 2002/155777 A, in which, as of a certain motor temperature, the vehicle is limited to a speed of 60 km/h. The disadvantage in this case is that, only when a certain temperature is reached, measures are taken, and thereby the utilization of the vehicle is abruptly greatly restricted by the speed limitation.

It is an object of the present invention to provide a method and a device to determine ahead of time a component part-conditioned power limitation for electric drives.

### SUMMARY

In accordance with the present invention, an example method is provided for determining a power reserve of an electric drive, particularly for use in a drive train of a motor vehicle, having the steps: determining a power limit of an electric drive, which forms a limit of the convertible power of the electric drive; recording a requested, provided or applied torque of the electric drive; determining a power reserve, which forms a power beyond the requested, provided or applied torque within the determined power limit of the electric drive; and displaying the power reserve using a display device.

Furthermore, an example device is also provided for determining a power reserve of an electric drive, particularly for use in a drive train of a motor vehicle having at least one control unit which is connected to a display device, and is designed to carry out the method of the type described above.

Finally, in accordance with the present invention, an example motor vehicle drive train is provided having an electric drive for providing drive power and an example device of the type described above.

Within the meaning of the present invention, by convertible power one should understand both regenerative power and motor power. Within the meaning of the present invention, the electrical drive is able to be operated both regeneratively and by a motor. By provided torque, one should understand, within the meaning of the present invention, a torque given off, and by an applied torque one should understand a torque applied to the electric drive in regenerative operation. By a requested torque one should understand a currently requested torque or, in the widest sense, also a torque required in the future.

In accordance with the present invention, one is able to indicate to the user of the electric drive, and particularly to the driver of a vehicle having such an electric drive, at any time what power quantity, starting from the power converted up to now as well as the currently converted power, is still convertible, until the power limit of the electric drive is reached. Thereby the user or driver is able to estimate at any time whether power beyond the current power is able to be converted, and is perhaps able to be retrieved. In other words, it is indicated to the user or driver whether or when one should expect a regulating down of the power or a restriction in the convertible power. Thereby, in particular, the vehicle behavior becomes predictable, so that the safety of the passengers is generally increased.

It is of special preference if the determination of the power limit takes place based on a load limit, particularly a thermal load limit, of at least one component of the electric drive. Because of the separate observation of the individual electric components of the drive, the determination of the load limit is more precise. In this context, it is particularly preferred to include the earlier loads of the electric drive and particularly the increased temperatures created thereby or temperature differences of the electric drive in the determination of the load limit. In this manner, it is possible to determine the load limit even more precisely.

It is especially preferred if the load limit is determined on the basis of a model of the electric component. The determination of the load limit thereby becomes more precise.

Moreover, it is preferred if the model for determining the load limit is selected based on the current power reserve, from a plurality of models. By doing this, the model used is able to be adjusted to current conditions, whereby the load limit is able to be determined even more precisely.

It is preferred if the load limit is determined based on one of the components which will reach the load limit at the earliest time. In this manner, it is possible to determine the load limit even more precisely and securely.

It is further preferred if the determination of the power reserve takes place regularly or repeatedly, in discrete steps, the interval of the steps being reduced with decreasing power reserve. Thereby the calculating effort for determining the power reserve may be adapted to the requirement, the accuracy of the method being increased in critical situations at a decreasing power reserve.

It is alternatively preferred if the determination of the power reserve takes place continuously. Thereby the current value of the power reserve is always displayed, and for this reason, unexpectedly great changes are able to be detected and displayed more quickly.

Moreover, it is preferred when it is displayed whether the power reserve is sufficient for providing the currently requested torque. Because of that, the user or driver is able to prepare himself directly should the requested torque not be available.

It is also preferred if the duration is determined for which the requested torque is able to be provided, with respect to the power reserve. In particular, it is preferred if the duration is displayed, for which the requested torque is able to be provided. Thereby additional details may be provided to the user or driver, so that he is able to adjust his behavior to the available power reserve.

It is preferred, moreover, if the requested torque is regulated down when the load limit is reached. One may thereby avoid damage to the electric drive by overloading.

It is also preferred if a torque going beyond a constant power limit is only possible using a predefined input by the driver, it being displayed to the driver via the display device that the requested torque goes beyond the constant power limit. This ensures that the driver consciously calls for the additional power, whereby improved control of the available power is made possible. The constant power limit, in this context, is a limit of the permanently and durably convertible power, which is smaller than the power limit.

Furthermore, it is preferred if a requested torque is not made available, provided the power limit of at least one electric component has been reached or after the expiration of a predefined time span. This may avoid damage to the components of the electric drive, since the power limits of the component are not reached.

Furthermore, it is preferred if the power limit, and particularly the constant power limit, is determined based on route data of a planned trip route, the power reserve being determined based on a torque that will be required for the planned trip route. Based on the required torque thus predetermined, the constant power limit may be dynamically adjusted and reported back to the driver. Thereby a power reserve required in the future may be determined, whereby the power reserve is able to be adjusted even more precisely to a future requirement. In this instance, it is of particular advantage if the driver receives a warning if the driver is letting an increased power reserve required in the future go down. The vehicle may thereby become generally more reliable. It is furthermore preferable if the driver is given a feedback via the display, provided no power going beyond the constant power limit and no torque going beyond the constant power limit is able to be called up. The driver is thus able to prepare himself for the unavailable power and the unavailable torque, whereby the safety of the vehicle is increased.

It is furthermore preferred to determine a power limit of an electric drive in a regenerative mode, and to report back to the driver if an electric drive of a vehicle is able to admit a regenerative torque which is able permanently to exceed the power limit of at least one electrical component. One is thereby able to provide feedback to the driver which enables an adjustment of the braking (provided the current traffic situation permits this adjustment) which counteracts early a power restriction during the regenerative torque, and thus an intervention of another braking system, that does not regenerate energy, may be avoided.

In one specific embodiment of the present invention, it is provided that one should assure the driver explicit operating possibilities, which make possible for him an improved control of the available power of the vehicle having at least one electric drive. In this context, the driver has permanently made available to him only the power that does not exceed the power limit of all electrical components. In this specific embodiment variant, the driver additionally receives the possibility of requesting additional power limited as to time. This request may take place via specified input actions, such as on a gas pedal or an additional specified operating unit. When the driver calls up the additional power, he is given feedback as to the extent at which it will be available in the immediate future.

In this specific embodiment variant it is further preferred not to enable the driver to request additional power if the power limit of at least one electrical component has already been reached or will probably be reached in a specified time span. The driver may be given feedback in a display unit that an additional power request is not possible at a particular point in time.

In one additional specific embodiment of the present invention, data of a digital or of alternatively stored data on a possible route are taken into account in such a way that future requests to be expected are observed from a known or expected routing of the road to give an available power (e.g. based on slopes and expected speeds) during the ascertainment of a permanently available power limit. The driver may thereby receive advice, via a display unit, on the extent he should lower a power reserve needed in the future.

As an alternative, in the last-named specific embodiment, the driver may also request an adjustment in the vehicle behavior, in that the permanently available power limit is also ascertained based on future requirements (which may possibly briefly exceed the technical constant power limit, that is, the constant power limit is appropriately lowered ahead of time).

### BRIEF DESCRIPTION OF THE DRAWINGS

FIG. 1 in schematic form, shows a motor vehicle having a drive train, which is equipped with an electric drive and a control unit for controlling the electric drive.

FIG. 2 in schematic form, shows a flow chart of a method for determining a power reserve of an electric drive.

FIGS. 3a-d in exemplary fashion, show four different states of a display for displaying different power reserves.

### DETAILED DESCRIPTION OF EXAMPLE EMBODIMENTS

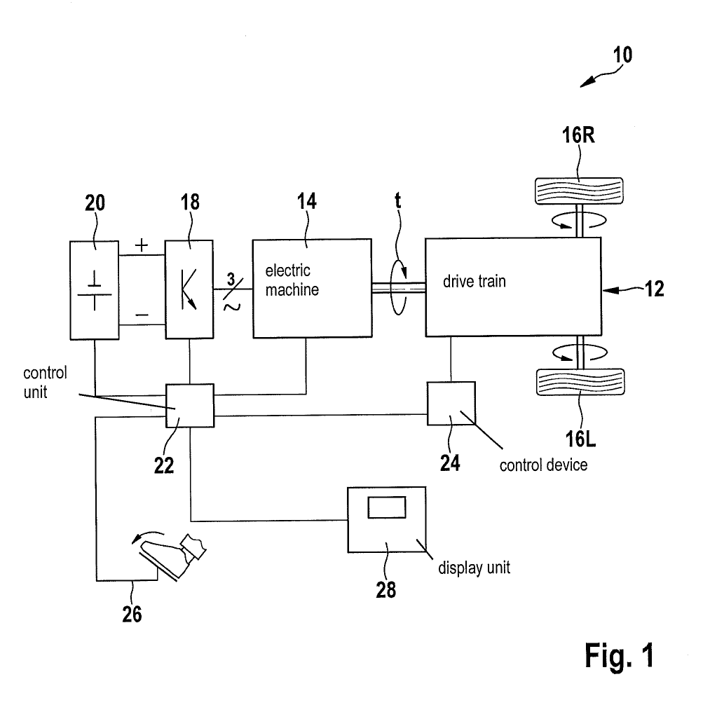

FIG. 1 schematically shows a motor vehicle, which is denoted by 10 as a whole. Motor vehicle 10 has a drive train 12, which in the present case has an electric machine 14 to provide driving power. Drive train 12 drives driven wheels 16L, 16R of vehicle 10.

Electric machine 14 provides a torque t at an output shaft and rotates at an adjustable rotational speed.

Drive train 12 may be set up to drive vehicle 10 on its own, with the aid of electric machine 14 (electric vehicle). As an alternative, electric machine 14 may be part of a hybrid drive train 12, and drive train 12 may include an additional driving motor (not denoted further in FIG. 1) such as an internal combustion engine or the like. In such a case, drive train 12 may additionally have a transmission and the like.

Electric machine 14 is controlled by power electronics 18, which in the present case supplies the electric machine with electric power in a three-phased manner. It is generally also possible that electric machine 14 might be developed as a direct current machine or even as an alternating current machine having one phase. Power electronics 18 is connected to an energy supply 20 such as a battery 20, for example, which is used to supply electric machine 14 with electric power and/or to store electric power generated by the electric machine in regenerative operation. Electric machine 14 and power electronics 18 are controlled directly or indirectly using one or more control units 22. The control unit or control units 22 are also connected to a control device 24, which controls additional components of drive train 12. Control unit(s) 22 is/are connected to an input unit 26 which, in the present case, is developed as a gas pedal of motor vehicle 10. Input unit 26 may also be developed in another form. Control unit (2) 22 is/are further connected to display unit 28, in order to show a driver of vehicle 10 signals and information.

Control unit(s) 22 are connected directly or indirectly to electric machine 14, power electronics (18) and energy supply 20, in order to take up measured values, using measuring devices not shown, concerning the current state, such as rotational speed, temperature, loading state or the like, carrying out thereby forward-going calculations, and showing the measured values or calculation results to the driver of vehicle 10 via display unit 28. Control unit(s) 22 are further connected to input device or gas pedal 26, in order to receive an input signal in the form of a power request. Appropriately to the input signal, the control unit(s) control electric machine 14 and power electronics 18, in order to initiate torque t and the rotational speed on the drive shaft.

Electric machine 14 is basically controlled by control unit(s) 22 in such a way that components of electric machine 14 and/or of power electronics 18 are not overloaded and particularly so that no overheating of components of electric machine 14 or power electronics 18 is to be expected. Control unit(s) 22 are able to control electric machine 14 temporarily beyond a so-called nominal operation, in order to make available temporarily and briefly increased power of electric machine 14 in the form of torque t or rotational speed on the drive shaft, or to convert a torque in regenerative operation into electric power. Depending on the magnitude of the permanent loading of electric machine 14 or of power electronics 18, an increased power conversion is possible briefly or for the longer term. A maximally durable power of electric machine 14, in this instance, forms a constant power limit which may be exceeded briefly. If electric machine 14 or power electronics 18 has reached a limit of load capacity, no additional power is able to be provided, and control unit(s) 22 regulate down a torque t requested in addition by input device 26, in order not to damage permanently electric machine 14 or power electronics 18. If the power limit has been reached, no more power is converted in recuperating operation or in regenerating operation, and control unit(s) 22 do not initiate the regenerative operation, or only up to the admissible power limit. In this case, vehicle 10 is braked or additionally braked by an alternative or by a usual method.

In order to make the behavior of vehicle 10, and particularly of electric machine 14 predictable to the driver, control unit(s) 22 determine a power reserve which is available in addition to the currently provided drive power and converted power, until the load-conditioned power limit of electric machine 14 or of power electronics 18 is reached. This power reserve is displayed by control unit(s) 22 to the driver via display means 28. The driver is thereby informed at all times as to what additional convertible power is available in the form of torque t, and is able to adapt his driving behavior accordingly.

If the driver requests an additional torque t, which exceeds the load limit or will do so in the direct future, and if no power reserve is available, the driver is warned via display means 28, before control unit(s) 22 regulate down the requested power or the power given off by electric machine 14.

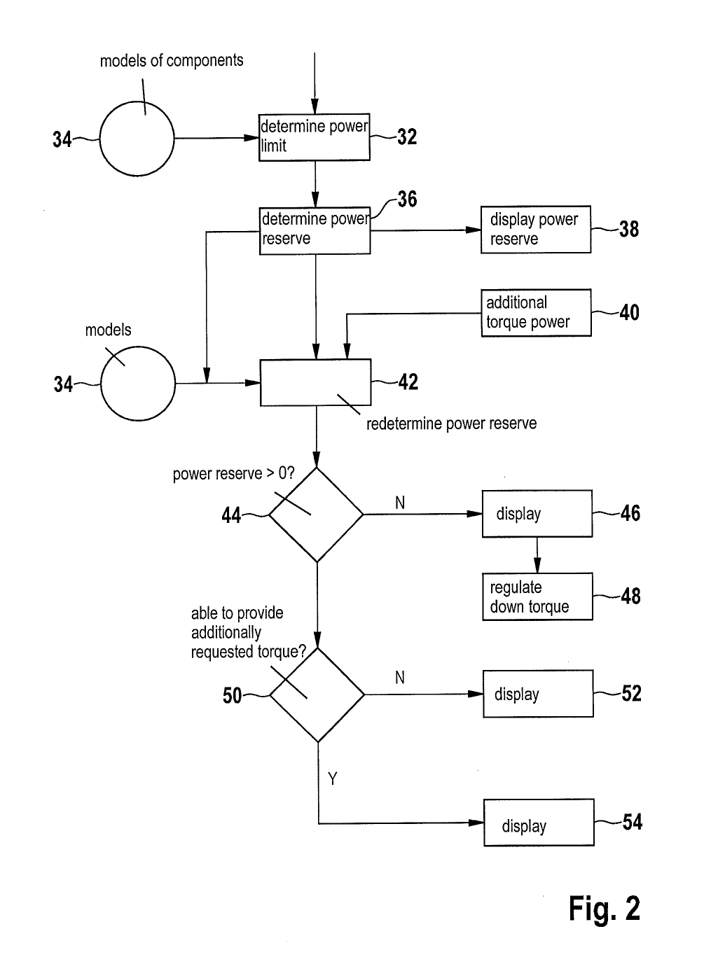

FIG. 2 shows schematically a flow chart of a method for determining a power reserve of an electric drive 14. The method is altogether designated by 30 in FIG. 2. Method 30 is initiated at 32, with a determination of a power limit of a component of electric drive 14 or of power electronics 18 by control unit(s) 22. The determination of the power limit of the electric drive is based on models 34 of the individual electric components, with the aid of which the loadability of the components at a corresponding torque and corresponding drive power is calculated by control unit(s) 22. From models 34, a model is selected whose associated component reaches the loading limit first usually or under the prevailing conditions. Control unit(s) 22 determine at 36 a power reserve for permanent operation without additional torque requests by the driver, but based on the ascertained power limit and continuously provided torque t and the corresponding drive power. The power reserve is displayed to the driver at 38, using display unit 28. If the driver requests an additional torque t and an additional drive power, as is shown at 40, the power reserve is redetermined at 42. In this context, the determination of the power reserve takes place based on models 34, the models 34 used being selected based on the currently available power reserve. The determination of the power reserve further takes place at 42 based on the power reserve up to now and the additionally requested torque requested

At 44 it is checked whether the power reserve is greater than zero or equal to zero. If the power reserve is equal to zero, a corresponding signal is sent to the driver via display unit 28, as is shown at 46, and the requested torque and the provided torque are regulated down and not provided, as is shown at 48. If it is determined at 44 that the power reserve is greater than zero, it is ascertained at 50 whether the power reserve is or will be greater than zero for a predetermined time period while taking into account the additionally requested torque and the additionally requested drive power. In other words, it is checked at 50 whether the additionally requested torque t is able to be provided for the predefined time period, with respect to the power reserve. If additionally requested torque t cannot be made available for the predefined time period, a corresponding signal is sent to the driver via display unit 28. If the power reserve is big enough so that the additionally requested torque t and the additionally requested drive power is able to be provided for the predefined time period, this is displayed to the driver at 54, using display unit 28, and electric machine 14 is correspondingly controlled using control unit(s) 22.

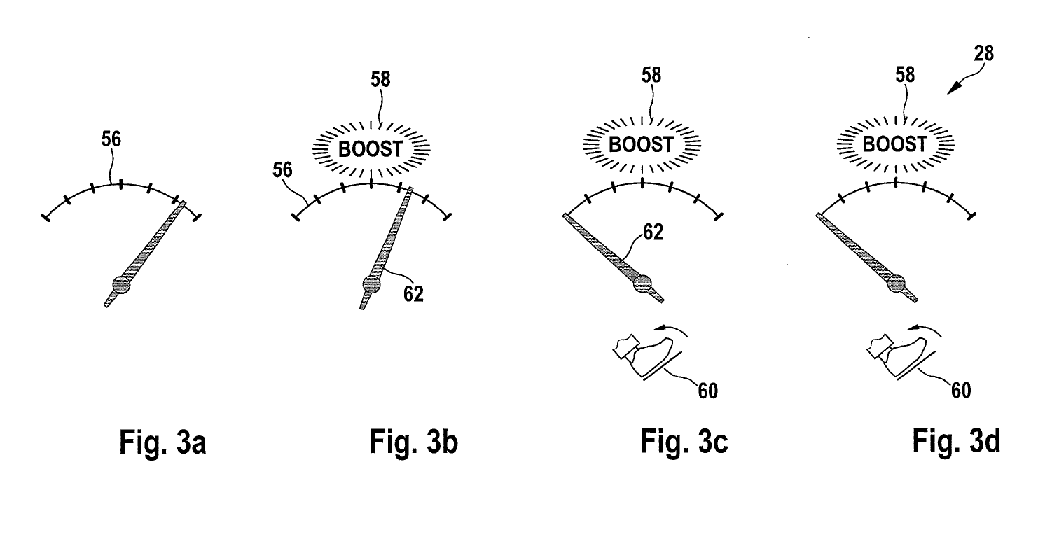

In FIGS. 3a to d, possible different display modes of display device 28 or display unit 28 are shown for different situations.

Display unit 28 has generally three display sections 56, 58, 60. The power reserve is continuously displayed by display section 56. Display section 56 is developed in this case, in exemplary fashion, as an analog pointer display, and continuously displays the power reserve. Display section 58 indicates whether a power exceeding the normal constant power is being requested by the driver. In one particular specific embodiment, this additional power is only able to be requested via specific input actions of the driver. Display section 58 is developed in this case as a light-emitting element and, depending on the situation, may display, for instance, a green, yellow or red color signal. Display unit 28 also has a display section 60, which is developed as a light-emitting symbol, and is shown in a yellow or red color, depending on the situation. Display section 60 shows the driver that no additional power is available, and immediately or shortly the requested torque will be taken back, and that the driver should take his foot of the gas.

FIG. 3a shows a display mode of display unit 28, for the case in which the driver is not requesting any power, in the form of torque t, that goes beyond the constant power. In this context, display section 56 shows the currently available power reserve. Display section 58 and display section 60 are deactivated.

FIG. 3b shows a display of display unit 28 for the case in which the driver is requesting a power going beyond the constant power, in the form of torque t, and the power reserve is able to be retrieved for a specified minimum duration.

Display section 56 displays the available power reserve in this instance. Display section 58 informs the driver that power exceeding the constant power has been requested. In this case, display section 58 preferably lights up in green, since the requested torque is able to be called up for a specified duration. With decreasing power reserve, a pointer 62 of display section 56 approaches the lower limit corresponding to the reduction in the power reserve.

FIG. 3c shows the state of the display in the case in which the driver requests power in the form of a torque t that exceeds the constant power, and the power reserve is not available for a predefined minimum duration. Display section 58 tells the driver that a power exceeding the constant power has been requested. In this case, display section 58 lights up in yellow, since there is still reserve power present, but requested torque t cannot be provided over a predefined minimum duration. In this case, pointer 62 has reached the lower border of display section 56. Furthermore, display section 60 lights up, preferably in yellow, to tell the driver that, shortly, the torque will no longer be available, and torque t will be regulated down.

FIG. 3d shows a state of display unit 28 in the case where the driver requests power, exceeding the constant power, in the form of a torque t, and the loading limit of electric drive 14 has already been reached or will probably be reached in a specified time span. In this case, the requested power will not be provided. Display section 58 preferably lights up in red, and display section 60 preferably shows in red the action instruction that the driver should take his foot off the gas. Once the load limit of electric drive 14 has been reached, the power of the vehicle is actively regulated down.

In this way, display unit 28 is able to inform the driver inclusively on the power reserve, and on whether a requested torque or requested additional power is available for a predefined time period.

1-15. (canceled)

16. A method for determining a power reserve of an electric drive for use in a drive train of a motor vehicle, the method comprising:
determining a power limit of the electric drive, which forms a limit of convertible power of the electric drive;
recording a requested, provided or applied torque of the electric drive;
determining a power reserve which forms a power that is convertible above the requested, provided or applied torque within the determined power limit of the electric drive; and
displaying the power reserve using a display device.

17. The method as recited in claim 16, wherein the determining of the power limit takes place based on a thermal load limit of at least one component of the electric drive.

18. The method as recited in claim 16, wherein the load limit is determined based on a model of the electric component.

19. The method as recited in claim 17, wherein the model for determining the load limit is selected, based on the current power reserve, from a plurality of models.

20. The method as recited in claim 16, wherein the power limit is determined based on a component which reaches its load limit at the earliest time.

21. The method as recited in claim 16, wherein the determining of the power reserve takes place regularly in discrete steps, and wherein a distance of the steps is reduced with declining power reserve.

22. The method as recited in claim 16, wherein the determining of the power reserve takes place continuously.

23. The method as recited in claim 16, wherein an indication of whether the power reserve is sufficient to provide the requested torque is displayed.

24. The method as recited in claim 16, wherein a duration is determined during which the requested torque is able to be provided with reference to the power reserve.

25. The method as recited in claim 16, wherein the requested torque is regulated down when the load limit is reached.

26. The method as recited in claim 16, wherein a torque exceeding a constant power limit is possible only using a predefined input by the driver and wherein the driver receives a feedback, via the display device, that the requested torque exceeds the constant power limit.

27. The method as recited in claim 16, wherein a requested torque is not provided if one of the power limit of at least one electrical component has been reached, or after the expiration of a predefined time span will have been reached.

28. The method as recited in claim 16, wherein the power limit is determined based on route data over a planned travel route and wherein the power reserve is determined based on a torque which will be needed for a planned travel route.

29. A device for determining a power reserve of an electric drive for use in a drive train of a motor vehicle, comprising:
a display unit; and
a control unit connected to the display unit, the control unit configured to determine a power limit of the electric drive, which forms a limit of convertible power of the electric drive, to record a requested, provided or applied torque of the electric drive, to determine a power reserve which forms a power that is convertible above the requested, provided or applied torque within the determined power limit of the electric drive, and to display the power reserve using a display device.

30. A motor vehicle drive train, comprising:
an electric drive for providing a drive power; and
a device for determining a power reserve of the electric drive, the device including a display unit, and a control unit connected to the display unit, the control unit configured to determine a power limit of the electric drive, which forms a limit of convertible power of the electric drive, to record a requested, provided or applied torque of the electric drive, to determine a power reserve which forms a power that is convertible above the requested, provided or applied torque within the determined power limit of the electric drive, and to display the power reserve using a display device.
